(19) United States
(12) Patent Application Publication
(10) Pub. No.: US 2026/0074595 A1
(43) Pub. Date: Mar. 12, 2026

(54) ROTOR MANUFACTURING APPARATUS AND ROTOR MANUFACTURING METHOD

(71) Applicant: TOYOTA BOSHOKU KABUSHIKI KAISHA, Aichi-ken (JP)

(72) Inventors: Yuto ITO, Takahama-shi (JP); Yuki WAKIMOTO, Tokai-shi (JP); Masaki SUGIYAMA, Okazaki-shi (JP)

(73) Assignee: TOYOTA BOSHOKU KABUSHIKI KAISHA, Aichi-ken (JP)

(21) Appl. No.: 19/318,077

(22) Filed: Sep. 3, 2025

(30) Foreign Application Priority Data
Sep. 9, 2024 (JP) 2024-155077

(51) Int. Cl. H02K 15/035; H02K 1/276

(52) U.S. Cl. CPC H02K 15/035; H02K 1/276

(57) ABSTRACT

A rotor manufacturing apparatus includes a first die and a second die configured to be clamped to sandwich the rotor core including a magnet accommodated in a slot, a caul plate that includes a filling pot and is configured to be disposed between the first die and the rotor core, and a plunger that is configured to extrude plastic in the filling pot toward the slot. The plunger includes an enlarged-dimension portion and a reduced-dimension portion that protrudes from the enlarged-dimension portion and forms a distal end of the plunger. When the plunger extrudes the plastic in the filling pot, the plunger moves at least to a position at which the enlarged-dimension portion is flush with a facing surface.

### CROSS-REFERENCE TO RELATED APPLICATIONS

This application is based upon and claims the benefit of priority from Japanese Patent Application No. 2024-155077, filed on Sep. 9, 2024, the entire contents of which are incorporated herein by reference.

### BACKGROUND

### 1. Field

The present disclosure relates to a rotor manufacturing apparatus and a rotor manufacturing method.

### 2. Description of Related Art

JP2022-116745A discloses a manufacturing apparatus for a rotor (referred to as a “core unit” in the publication), which is a component of a rotating electric machine. The rotor includes an iron core body, permanent magnets inserted into magnet insertion holes of the iron core body, and a plastic filler filling in the magnet insertion holes.

The manufacturing apparatus described in the publication includes a lower die, an upper die having receiving holes, an auxiliary plate having plastic flow passages, and extrusion portions for extruding a molten plastic into the magnet insertion holes. The lower die supports the jig on which the iron core body is placed from below. The auxiliary plate is placed on the upper surface of the iron core body. The upper die sandwiches the jig, the iron core body, and the auxiliary plate together with the lower die. The extrusion portion fills the magnet insertion holes with plastic by extruding the plastic within the receiving holes of the upper die through the plastic flow passages of the auxiliary plate.

After the plastic has solidified and the extrusion portions have retracted from the receiving holes, the upper die and the auxiliary plate are separated from each other either by raising the upper die or by lowering the lower die.

In the manufacturing apparatus disclosed in the publication, since the extrusion portions do not protrude from the receiving holes when extruding the plastic, the solidified plastic is located in the receiving holes. As a result, when the upper die and the auxiliary plate are separated from each other, some of the plastic may break off and remain in the receiving holes. In this case, it is necessary to remove the plastic from the receiving holes.

On the other hand, if the plastic flow passages are made relatively deep and the extrusion portions are advanced into the plastic flow passages so as to avoid the above-described drawback, the depth of the region in which plastic is present may locally increase within the plastic flow passages. In this case, the flowability of the plastic extruded by the extrusion portions may decrease, resulting in insufficient amount of plastic supplied to the magnet insertion holes.

In view of the above, there remains room for improvement in increasing the productivity of rotor manufacturing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rotor manufacturing apparatus is configured to manufacture a rotor including a tubular rotor core having a slot extending therethrough in an axial direction, a magnet accommodated in the slot, and a plastic filling the slot to fix the magnet to the rotor core. The rotor manufacturing apparatus a first die, a second die, a caul plate, and a plunger. The first die and the second die are configured to be clamped to sandwich, in the axial direction, the rotor core, including the magnet accommodated in the slot. The caul plate includes a filling pot configured to introduce the plastic into the slot. The caul plate is configured to be disposed between the first die and the rotor core. The plunger is disposed in a receiving hole formed in the first die. The plunger is configured to protrude from and retract into a facing surface of the first die facing the caul plate and to extrude the plastic in the filling pot toward the slot. The plunger includes an enlarged-dimension portion and a reduced-dimension portion protruding from the enlarged-dimension portion to form a distal end of the plunger. The reduced-dimension portion has a width smaller than that of the enlarged-dimension portion. When the plunger extrudes the plastic in the filling pot, the plunger moves at least to a position at which the enlarged-dimension portion is flush with the facing surface.

In another general aspect, a rotor manufacturing method is provided that is used to manufacture a rotor including a tubular rotor core having a slot extending therethrough in an axial direction, a magnet accommodated in the slot, and a plastic filling the slot to fix the magnet to the rotor core. The rotor manufacturing method comprising: clamping a first die and a second die with the rotor core and a caul plate sandwiched therebetween in the axial direction in a state in which the caul plate is disposed at an end face in the axial direction of the rotor core accommodating the magnet, the caul plate including a filling pot configured to introduce the plastic into the slot; and filling the slot with the plastic by extruding the plastic in the filling pot by using a plunger disposed in a receiving hole formed in the first die, the plunger being configured to protrude from and retract into a facing surface of the first die facing the caul plate. The plunger includes an enlarged-dimension portion and a reduced-dimension portion protruding from the enlarged-dimension portion to form a distal end of the plunger. The reduced-dimension portion has a width smaller than that of the enlarged-dimension portion. The filling the slot with the plastic includes moving the plunger at least to a position at which the enlarged-dimension portion is flush with the facing surface.

Other features and aspects will be apparent from the following detailed description, the drawings, and the claims.

### BRIEF DESCRIPTION OF THE DRAWINGS

FIG. 1 is a perspective view of a rotor according to an embodiment.

FIG. 2 is a cross-sectional view of the rotor shown in FIG. 1.

FIG. 3 is a cross-sectional view of a rotor manufacturing apparatus according to the embodiment.

FIG. 4 is a cross-sectional view of one of the plungers and the caul plate shown in FIG. 3.

FIG. 5 is a cross-sectional view showing a supporting step and a transferring step in a rotor manufacturing method.

FIG. 6 is a cross-sectional view showing a die clamping step in the rotor manufacturing method.

FIG. 7 is a cross-sectional view showing a filling step in the rotor manufacturing method.

FIG. 8 is a cross-sectional view showing a separating step in the rotor manufacturing method.

FIG. 9 is a cross-sectional view showing a die opening step in the rotor manufacturing method.

FIG. 10 is a cross-sectional view of a rotor manufacturing apparatus according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

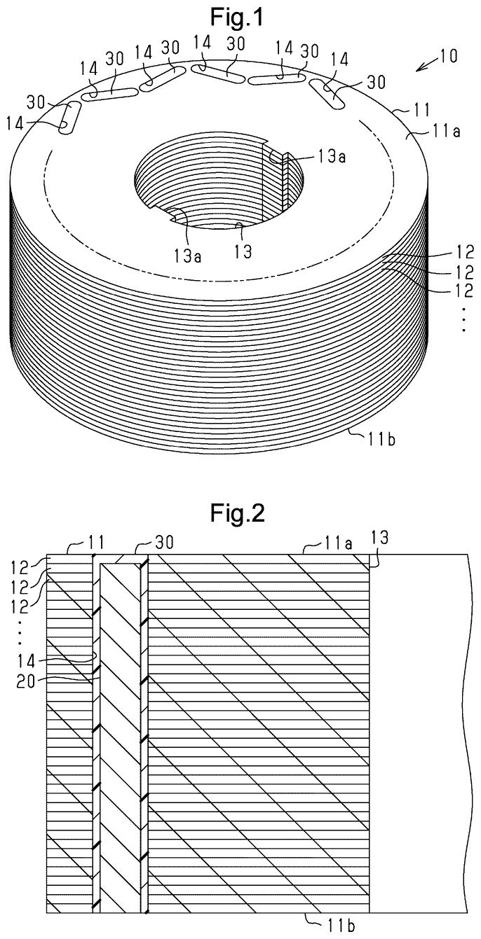

A manufacturing apparatus for a rotor and a method of manufacturing a rotor according to an embodiment will now be described with reference to FIGS. 1 to 9.

First, a rotor 10 manufactured by the rotor manufacturing apparatus (hereinafter, referred to as a manufacturing apparatus 40) of the present embodiment will be described.

### Configuration of the Rotor 10

As shown in FIGS. 1 and 2, the rotor 10 includes a rotor core 11, multiple magnets 20, and multiple pieces of plastic 30. The rotor 10 is used in, for example, a magnet-embedded motor.

The rotor core 11 is substantially cylindrical. The rotor core 11 is formed, for example, by stacking iron core pieces 12 that are punched out from a magnetic steel sheet.

In the following description, the axial direction of the rotor core 11 will simply be referred to as an axial direction. The radial direction of the rotor core 11 will simply be referred to as a radial direction. The circumferential direction of the rotor core 11 will simply be referred to as a circumferential direction.

The rotor core 11 includes a first end face 11a and a second end face 11b, which are located on opposite sides in the axial direction.

The rotor core 11 includes a center hole 13 and slots 14. A shaft (not shown) is inserted into the center hole 13. The slots 14 are formed in the outer circumferential portion of the rotor core 11 at intervals in the circumferential direction. The center hole 13 and the slots 14 extend through the rotor core 11 in the axial direction. In other words, the center hole 13 and the slots 14 both open in the first end face 11a and the second end face 11b.

As shown in FIG. 1, the center hole 13 is substantially circular in plan view. Two protruding keys 13a, which are opposed to each other in the radial direction, are provided on the inner surface of the center hole 13. The keys 13a are fitted into keyways provided in the shaft (not shown) to restrict relative movement between the rotor core 11 and the shaft in the circumferential direction.

The cross-sectional shape of each slot 14 orthogonal to the axial direction is a substantially rectangular shape having long sides and short sides. The cross-sectional shape of each slot 14 is constant over the entire length in the axial direction.

The magnets 20 are, for example, permanent magnets. Each slot 14 receives one of the magnets 20. The magnets 20 are fixed to the rotor core 11 by the plastic 30 filling the slots 14.

Each magnet 20 has a shape elongated in the axial direction. The dimension of each magnet 20 in the axial direction is shorter than the dimension of the rotor core 11 in the axial direction. Each magnet 20 has a substantially rectangular cross section orthogonal to the axial direction.

One end face in the axial direction of each magnet 20 is located, for example, inward of the first end face 11a in the axial direction. The other end face of each magnet 20 on the opposite side in the axial direction from the one end face is, for example, flush with the second end face 11b.

The plastic 30 is, for example, a thermosetting plastic. The plastic 30 fills, for example, the entire circumference of each magnet 20 between the inner surface of the slot 14 and the outer surface of the magnet 20. The plastic 30 covers one end face in the axial direction of the magnet 20 and is flush with the first end face 11a of the rotor core 11.

### Overall Configuration of the Manufacturing Apparatus 40

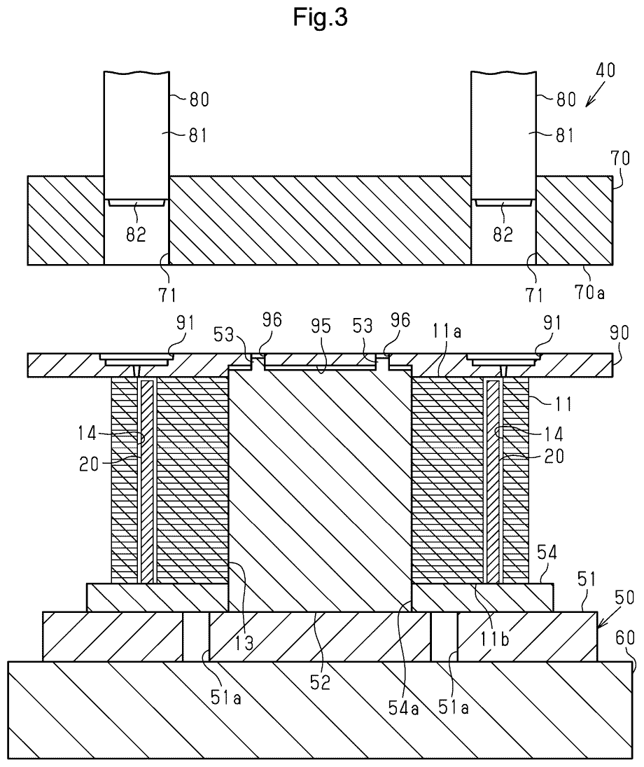

As shown in FIG. 3, the manufacturing apparatus 40 includes a support jig 50, a fixed die 60, a movable die 70, multiple plungers 80, and a caul plate 90. The fixed die 60 is an example of a second die. The movable die 70 is an example of a first die.

The support jig 50 supports the rotor core 11 from below. The fixed die 60 supports the support jig 50 from below. The movable die 70 is disposed above the fixed die 60. The movable die 70 is configured to be moved toward and away from the fixed die 60 in the vertical direction. The fixed die 60 and the movable die 70 are configured to be clamped with the rotor core 11 sandwiched therebetween in the axial direction. The caul plate 90 is disposed between the movable die 70 and the rotor core 11 when the fixed die 60 and the movable die 70 are clamped. Each plunger 80 is configured to protrude from and retract into the movable die 70.

### Support Jig 50

The support jig 50 includes a base plate 51, a post 52, and a spacer 54. The base plate 51 is flat. The post 52 protrudes upward from a central portion of the base plate 51. The spacer 54 is stacked on the upper surface of the base plate 51 and supports the second end face 11b of the rotor core 11.

The base plate 51 has multiple through-holes 51a extending therethrough in the thickness direction. The through-holes 51a are provided at intervals so as to surround the post 52.

The post 52 has a columnar shape. The post 52 extends through the spacer 54. The post 52 is inserted into the center hole 13 of the rotor core 11. The post 52 includes keyways (not shown) in the outer circumferential surface. The keyways are engaged with the two keys 13a of the rotor core 11 (see FIG. 1). When the keys 13a are engaged with the keyways, the rotor core 11 is positioned relative to the support jig 50. The post 52 includes multiple positioning pins 53 on the distal end face.

The spacer 54 has the shape of a flat plate. The spacer 54 has a center hole 54a into which the post 52 is inserted. Although not illustrated, the spacer 54 is configured to be raised and lowered along the post 52 by a lift mechanism that moves up and down through the through-holes 51a of the base plate 51. The rotor core 11 is removed from the support jig 50 by raising the spacer 54 in relation to the post 52.

### Configuration of the Movable Die 70

The movable die 70 has a flat facing surface 70a, which faces the caul plate 90.

The movable die 70 has multiple receiving holes 71 for receiving the plungers 80, respectively. The receiving holes 71 open in the facing surface 70a and extend through the movable die 70 in the vertical direction. The receiving holes 71 each have a circular cross section.

A clamping force is applied to the movable die 70 to when the fixed die 60 and the movable die 70 are clamped.

### Configuration of the Plungers 80

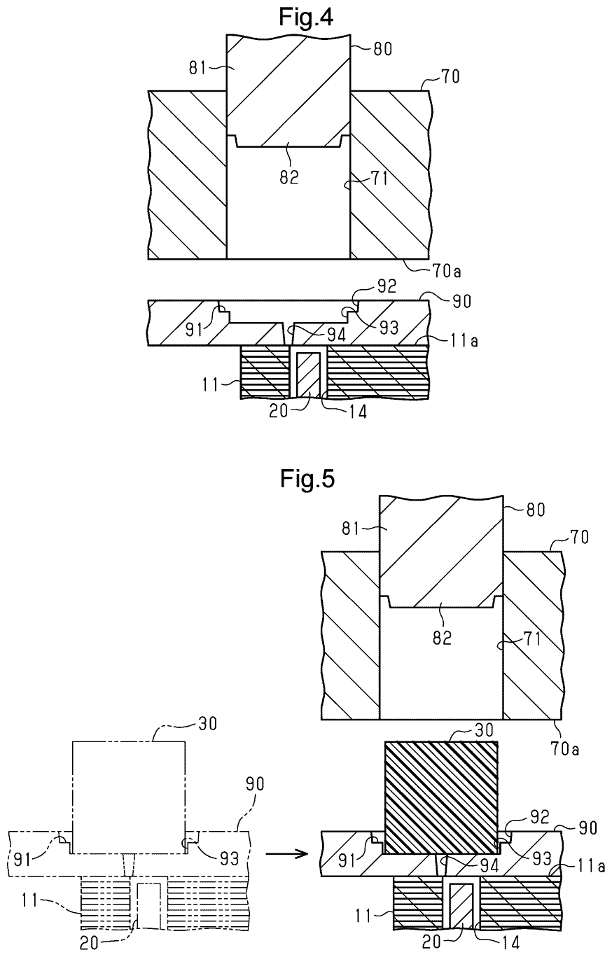

As shown in FIG. 4, each plunger 80 is configured to protrude from and retract into the facing surface 70a of the movable die 70 by moving up and down in the vertical direction inside the corresponding receiving hole 71 of the movable die 70. The plunger 80 pressurizes the plastic 30 in a filling pot 91, which will be discussed below, to fill the corresponding slot 14 with the plastic 30.

Each plunger 80 includes a first enlarged-dimension portion 81 and a first reduced-dimension portion 82. The cross sections of the first enlarged-dimension portion 81 and the first reduced-dimension portion 82 are circular.

The first enlarged-dimension portion 81 extends in the vertical direction. The first reduced-dimension portion 82 protrudes downward from the lower surface of the first enlarged-dimension portion 81. The first reduced-dimension portion 82 forms a distal end of the plunger 80. The first enlarged-dimension portion 81 and the first reduced-dimension portion 82 are continuous.

The width, that is, the diameter of the first enlarged-dimension portion 81 is constant in the axial direction. The diameter of the first enlarged-dimension portion 81 is substantially the same as the width, that is, the diameter of the receiving hole 71.

The width, that is, the diameter of the first reduced-dimension portion 82 is smaller than that of the first enlarged-dimension portion 81. The diameter of the first reduced-dimension portion 82 gradually increases toward the first enlarged-dimension portion 81 in the axial direction. The first reduced-dimension portion 82 has the shape of a truncated cone having a planar distal end face.

### Configuration of the Caul Plate 90

As shown in FIG. 3, the caul plate 90 is placed on the first end face 11a of the rotor core 11 supported by the support jig 50. The caul plate 90 has multiple filling pots 91 to introduce the plastic 30 into the slots 14.

As shown in FIG. 4, each filling pot 91 includes a second enlarged-dimension portion 92, a second reduced-dimension portion 93, and a connecting hole 94. The cross sections of the second enlarged-dimension portion 92, the second reduced-dimension portion 93, and the connecting hole 94 are circular.

The second enlarged-dimension portion 92 opens toward the movable die 70 in the upper surface of the caul plate 90. The width, that is, the diameter of the second enlarged-dimension portion 92 gradually increases toward the movable die 70 in the axial direction. The diameter of the second enlarged-dimension portion 92 is greater than the diameter of the first enlarged-dimension portion 81. The diameter of the second enlarged-dimension portion 92 is greater than the diameter of the receiving hole 71.

The second reduced-dimension portion 93 opens in the bottom surface of the second enlarged-dimension portion 92. The second reduced-dimension portion 93 has a width smaller than that of the second enlarged-dimension portion 92. Specifically, the diameter of the second reduced-dimension portion 93 is smaller than the diameter of the second enlarged-dimension portion 92. The diameter of the second reduced-dimension portion 93 is constant in the axial direction. The diameter of the second reduced-dimension portion 93 is greater than the maximum diameter of the first reduced-dimension portion 82. The diameter of the second reduced-dimension portion 93 is smaller than the diameter of the first enlarged-dimension portion 81 and the diameter of the receiving hole 71. Therefore, when the second reduced-dimension portion 93 is projected onto the receiving hole 71 in the axial direction, the entire second reduced-dimension portion 93 is located inside the receiving hole 71. The inner surface of the second reduced-dimension portion 93, which includes the bottom surface and the inner circumferential surface of the second reduced-dimension portion 93, is configured to support the columnar plastic 30 in its unmelted state.

The connecting hole 94 connects the second reduced-dimension portion 93 to the slot 14. The connecting hole 94 opens in the bottom surface of the second reduced-dimension portion 93 and in the lower surface of the caul plate 90. The opening of the connecting hole 94 in the bottom surface of the second reduced-dimension portion 93 is located in a region that faces the plunger 80 in the axial direction.

The width, that is, the diameter of the connecting hole 94 gradually increases toward the movable die 70 in the axial direction. The inclination angle of the inner circumferential surface of the connecting hole 94 with respect to the axial direction is, for example, the same as the inclination angle of the inner circumferential surface of the second enlarged-dimension portion 92 with respect to the axial direction.

As shown in FIG. 3, the caul plate 90 has a recess 95 and multiple positioning holes 96. The recess 95 opens in the lower surface of the central portion of the caul plate 90. The positioning holes 96 open in the upper surface of the recess 95 and extend through the caul plate 90 in the thickness direction.

The recess 95 receives the distal end of the post 52. The positioning pins 53 of the post 52 are inserted into the positioning holes 96. By inserting the positioning pins 53 into the positioning holes 96, the position of the caul plate 90 is determined relative to the support jig 50. Accordingly, the filling pots 91 and the slots 14 are connected to each other.

### Method for Manufacturing the Rotor 10

The method for manufacturing the rotor 10 includes a magnet housing step, an arranging step, a preheating step, a supporting step, a transferring step, a die clamping step, a filling step, a separating step, and a die opening step. The magnet housing step, the arranging step, the preheating step, the supporting step, the transferring step, the die clamping step, the filling step, the separating step, and the die opening step are performed in that order.

In the magnet housing step, the magnets 20 are housed in the respective slots 14 of the rotor core 11 supported by the support jig 50. At this time, the lower surface of each magnet 20 is in contact with the upper surface of the spacer 54.

In the arranging step, the caul plate 90 is placed on the first end face 11a of the rotor core 11 supported by the support jig 50. At this time, the positioning pins 53 are inserted into the positioning holes 96. The arranging step is performed, for example, in a state in which the rotor core 11 is not arranged between the fixed die 60 and the movable die 70.

In the preheating step, the support jig 50, the rotor core 11, and the caul plate 90 are put into a heating device (not shown) to be preheated to a specified temperature. Further, the fixed die 60 and the movable die 70 are preheated to a specified temperature.

As indicated by the long-dash double-short-dash lines in FIG. 5, in the supporting step, the plastic 30 having the shape of a column with a diameter smaller than that of the second reduced-dimension portion 93 is disposed on the second reduced-dimension portion 93 of the caul plate 90. Thus, the plastic 30 is supported by the second reduced-dimension portion 93. The plastic 30 supported by the second reduced-dimension portion 93 protrudes upward from the caul plate 90. Since the plastic 30 is supported by the second reduced-dimension portion 93, the caul plate 90 can be transferred while supporting the plastic 30. The supporting step is performed in a state in which the caul plate 90 is not located between the fixed die 60 and the movable die 70.

As indicated by the solid lines in FIG. 5, in the transferring step, the caul plate 90 and the rotor core 11, in a state in which the plastic 30 is supported by each second reduced-dimension portion 93, are transferred to a position between the fixed die 60 and the movable die 70 together with the support jig 50. In the transferring step, the rotor core 11 and the caul plate 90 are transferred to a position between the fixed die 60 and the movable die 70 by transferring the support jig 50.

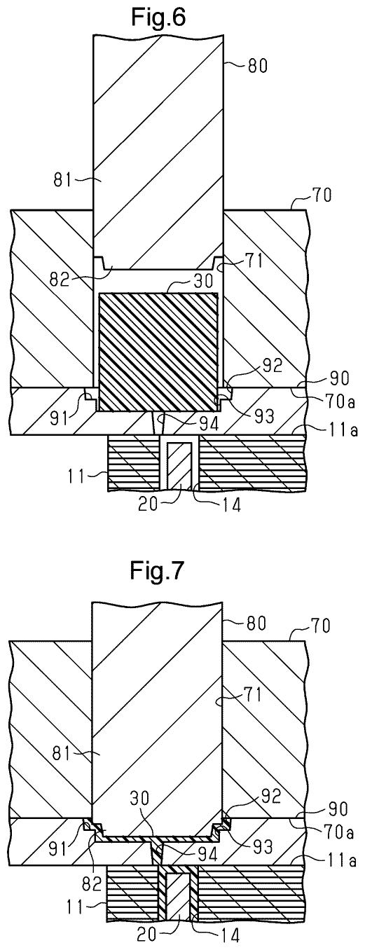

In the die clamping step, the fixed die 60 and the movable die 70 are clamped so as to sandwich the support jig 50, the rotor core 11, and the caul plate 90, which have been transferred in the transferring step. At this time, as shown in FIG. 6, the movable die 70 is lowered, so that the plastic 30 protruding upward from the caul plate 90 is housed in each receiving hole 71 of the movable die 70. The plastic 30 housed in each receiving hole 71 melts due to the heat from the preheating.

As shown in FIG. 7, in the filling step, each plunger 80 is lowered to pressurize the plastic 30 in the corresponding receiving hole 71 and the corresponding filling pot 91. When the plunger 80 extrudes the plastic 30 in the filling pot 91, the plastic 30 fills the slot 14. In the filling process, the first enlarged-dimension portion 81 moves beyond the facing surface 70a. Specifically, the first enlarged-dimension portion 81 moves into the second enlarged-dimension portion 92, and the first reduced-dimension portion 82 moves into the second reduced-dimension portion 93. When the plunger 80 extrudes the plastic 30 in the filling pot 91, the plunger 80 stops at a position at which the first enlarged-dimension portion 81 is located inside the second enlarged-dimension portion 92, and the first reduced-dimension portion 82 is located inside the second reduced-dimension portion 93. At this time, a gap is formed between the outer surface of the plunger 80 and the inner surface of the filling pot 91, allowing the plastic 30 to flow throughout that gap.

The plastic 30 filling the slots 14 is solidified by being heated by the heat from the preheating. The magnets 20 are thus fixed to the rotor core 11.

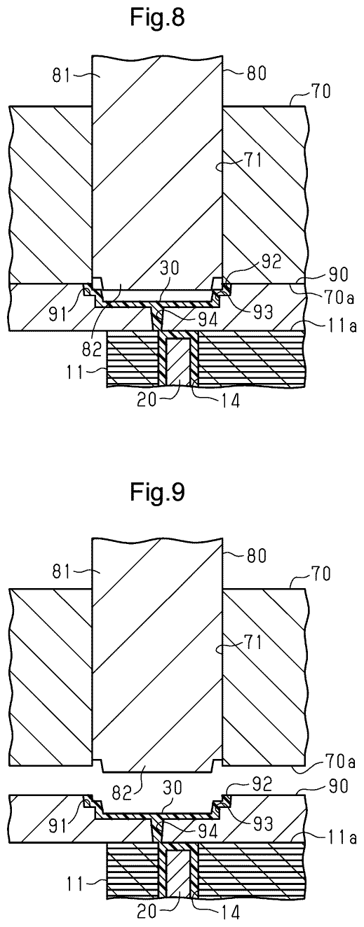

As shown in FIG. 8, in the separating step, only the plungers 80 retract from the caul plate 90 in a state in which the fixed die 60 and the movable die 70 are clamped. In other words, in the separating step, the plungers 80 retract from the caul plate 90 in a state in which the movable die 70 is in contact with the caul plate 90. As a result, the plastic 30 solidified in each filling pot 91 is separated from the corresponding plunger 80.

As shown in FIG. 9, in the die opening step, the movable die 70 is raised together with the plungers 80. As a result, the movable die 70 retracts from the rotor core 11 together with the plungers 80.

Although not illustrated, after the die opening step, the caul plate 90 and the support jig 50 are removed from the rotor 10. Then, pieces of the plastic 30 remaining in the filling pots 91 of the caul plate 90 are pushed out by pins or the like, so that the plastic 30 is separated from the caul plate 90.

### Operation of the Present Embodiment

When each plunger 80 extrudes the plastic 30 in the corresponding filling pot 91, the first enlarged-dimension portion 81 is located in the second enlarged-dimension portion 92. This prevents the plastic 30 from entering the receiving hole 71. Accordingly, the solidified plastic 30 is prevented from remaining in the receiving hole 71.

When the plunger 80 extrudes the plastic 30 in the filling pot 91, the first enlarged-dimension portion 81 stops inside the second enlarged-dimension portion 92, and the first reduced-dimension portion 82 stops inside the second reduced-dimension portion 93. This configuration suppresses a partial increase of the depth of the region in which the plastic 30 is present within the filling pot 91, as compared with a case in which the plunger 80 does not include the first reduced-dimension portion 82. This limits a reduction in the flowability of the plastic 30.

### Advantages of the Present Embodiment

(1) When the plunger 80 extrudes the plastic 30 in the filling pot 91, the plunger 80 stops at a position at which the first enlarged-dimension portion 81 is located inside the second enlarged-dimension portion 92, and the first reduced-dimension portion 82 is located inside the second reduced-dimension portion 93.

The above-described configuration improves the productivity in manufacturing the rotors 10.
(2) The width of the second enlarged-dimension portion 92 gradually increases toward the movable die 70 in the axial direction.

The above-described configuration readily separates the plastic 30 solidified in the filling pot 91 from the caul plate 90.
(3) The width of the second reduced-dimension portion 93 is constant in the axial direction.

The above-described configuration uses the second reduced-dimension portion 93 to support the plastic 30 in its unmelted state, thereby suppressing displacement of the plastic 30 relative to the caul plate 90. Specifically, the inner circumferential surface of the second reduced-dimension portion 93 restricts movement and tilting of the plastic 30 relative to the caul plate 90. As a result, the caul plate 90 can be transported with the plastic 30 supported by the second reduced-dimension portion 93. This allows the caul plate 90 to be positioned between the fixed die 60 and the movable die 70 after the plastic 30 has been supported in the caul plate 90. Accordingly, unlike a case in which the plastic 30 is provided in the caul plate 90 located between the fixed die 60 and the movable die 70, the above-described configuration can omit structural elements and steps otherwise required to provide the plastic 30 on the caul plate 90 located between the fixed die 60 and the movable die 70.
(4) The width of the second reduced-dimension portion 93 is smaller than the width of the receiving hole 71.

With this configuration, when the caul plate 90 is moved with the plastic 30 supported in the second reduced-dimension portion 93, the inner circumferential surface of the second reduced-dimension portion 93, which is smaller in diameter than the receiving hole 71, restricts displacement or tilting of the plastic 30 relative to the caul plate 90. Then, when the caul plate 90, with the plastic 30 supported in the second reduced-dimension portion 93, and the rotor core 11 are clamped by the fixed die 60 and the movable die 70, the plastic 30 can be placed within the receiving hole 71 of the movable die 70. Therefore, while achieving the advantage of the above item (3), this configuration also allows the fixed die 60 and movable die 70 to be clamped smoothly.
(5) Each filling pot 91 includes the connecting hole 94, which opens in the bottom surface of the second reduced-dimension portion 93 and connects the second reduced-dimension portion 93 to the slot 14.

With this configuration, since the connecting hole 94 opens in the second reduced-dimension portion 93, which receives the plunger 80, the filling pressure is more effectively applied to the plastic 30 flowing through the connecting hole 94, than in a configuration in which the connecting hole 94 opens in the bottom surface of the second enlarged-dimension portion 92. This limits a reduction in the flowability of the plastic 30 flowing through the connecting hole 94.
(6) The width of the second enlarged-dimension portion 92 is greater than the width of the receiving hole 71. The plunger 80 is configured to be retractable from the caul plate 90 in a state in which the movable die 70 and the fixed die 60 are clamped.

With the above-described configuration, when the plunger 80 retracts from the caul plate 90, the plastic 30 solidified in the filling pot 91 and the plunger 80 are separated from each other.

Since the plunger 80 includes the first reduced-dimension portion 82, the solidified plastic 30 is likely to adhere to the plunger 80. In this case, when the plunger 80 retracts from the caul plate 90, the plastic 30 and the plunger 80 may not be completely separated from each other, and some of the plastic 30 may remain attached to the plunger 80.

In this regard, with the above-described configuration, since the width of the second enlarged-dimension portion 92 is greater than that of the receiving hole 71, the outer peripheral edge of the plastic 30 solidified in the second enlarged-dimension portion 92 is covered by the facing surface 70a. Then, the plunger 80 retracts from the caul plate 90 in a state in which the movable die 70 and the fixed die 60 are clamped. As a result, the plastic 30, which has solidified in the filling pot 91, is pressed by the facing surface 70a of the movable die 70 during the retraction of the plunger 80, thereby enabling reliable separation of the plastic 30 from the plunger 80.
(7) In the filling step, the plunger 80 is stopped at a position at which the first enlarged-dimension portion 81 is located in the second enlarged-dimension portion 92 and the first reduced-dimension portion 82 is located in the second reduced-dimension portion 93.

This configuration achieves the same advantage as the advantage of the above item (1).
(8) In the supporting step, the plastic 30 is supported by the second reduced-dimension portion 93 in a state in which the caul plate 90 is not located between the fixed die 60 and the movable die 70. In the transferring step, the caul plate 90 in a state in which the plastic 30 is supported by the second reduced-dimension portion 93 is transferred to a position between the fixed die 60 and the movable die 70. In the die clamping step, the rotor core 11 and the caul plate 90, which has been transferred in the transferring step, are sandwiched between the movable die 70 and the fixed die 60 in the axial direction when the movable die 70 and the fixed die 60 are clamped.

Unlike a configuration in which the plastic 30 is provided in the caul plate 90 located between the fixed die 60 and the movable die 70, the above-described configuration can omit structural elements and steps otherwise required to provide the plastic 30 between the fixed die 60 and the movable die 70.
(9) In the separating step, the plunger 80 retracts from the caul plate 90 in a state in which the fixed die 60 and the movable die 70 are clamped, thereby separating the plastic 30 in the filling pot 91 from the plunger 80.

This configuration achieves the same advantage as the advantage of the above item (6).

### Modifications

The above-described embodiment may be modified as follows. The above-described embodiment and the following modifications can be combined as long as the combined modifications remain technically consistent with each other.

The width of the second enlarged-dimension portion 92 may be the same as the width of the receiving hole 71.

The plungers 80 may be configured to retract from the caul plate 90 simultaneously with the movable die 70 in the separating step.

The caul plate 90 in which the plastic 30 is supported by the second reduced-dimension portion 93 may be disposed on the first end face 11a of the rotor core 11 disposed between the fixed die 60 and the movable die 70.

The plastic 30 may be provided in the filling pot 91 of the caul plate 90 disposed between the fixed die 60 and the movable die 70.

Each filling pot 91 may have multiple connecting holes 94 that open in the bottom surface of the second reduced-dimension portion 93 and are connected to two or more of the slots 14, respectively.

The connecting hole 94 may open in the bottom surface of the second enlarged-dimension portion 92. In this case, the connecting hole 94 may open in a portion of the bottom surface of the second enlarged-dimension portion 92 that does not face the plunger 80.

The width of the second reduced-dimension portion 93 may be greater than or equal to the width of the receiving hole 71. In this case, it is preferable to dispose the plastic 30 in the filling pot 91 of the caul plate 90 disposed between the fixed die 60 and the movable die 70 without performing the supporting step.

The inclination angle of the inner circumferential surface of the second reduced-dimension portion 93 may be changed. For example, the width of the second reduced-dimension portion 93 may gradually increase toward the movable die 70 in the axial direction.

The inclination angle of the inner circumferential surface of the second enlarged-dimension portion 92 may be changed. For example, the width of the second enlarged-dimension portion 92 may be constant in the axial direction.

In the filling step, the first enlarged-dimension portion 81 may be stopped at a position on the same plane as the facing surface 70a. This configuration also prevents the plastic 30 from entering the receiving hole 71. Further, in this configuration, the entire first reduced-dimension portion 82 is located within in the filling pot 91. This configuration suppresses a partial increase of the depth of the region in which the plastic 30 is present within the filling pot 91, as compared with a case in which the plunger 80 does not include the first reduced-dimension portion 82.

The manufacturing apparatus 40 may be configured without the support jig 50.

In place of the support jigs 50, the caul plates 90 may be disposed between the fixed die 60 and the rotor core 11. In this case, each plunger 80 is configured to protrude from and retract into the fixed die 60.

The inclination angle of the outer circumferential surface of the first reduced-dimension portion 82 may be changed. For example, the width of the first reduced-dimension portion 82 may be constant in the axial direction.

The inclination angles of the inner circumferential surface of the second enlarged-dimension portion 92 and the inner circumferential surface of the connecting hole 94 may each be changed. For example, the width of the second enlarged-dimension portion 92 and the width of the connecting hole 94 may be constant in the axial direction.

The cross-sectional shape of the plunger 80 and the filling pot 91 is not limited to circular and may instead be, for example, polygonal.

The plastic 30 may be a thermoplastic.

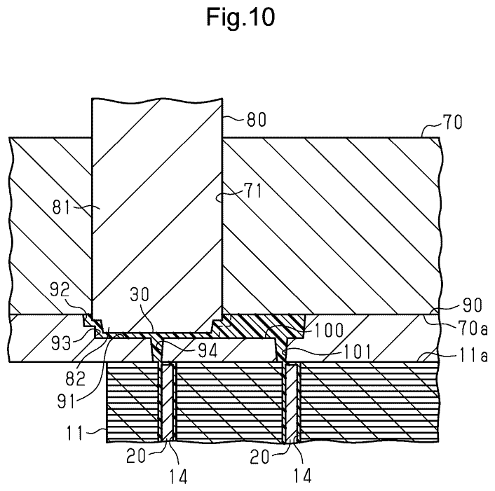

As shown in FIG. 10, the caul plate 90 may include a filling pot 91, a runner 100 connected to the filling pot 91, and a connecting hole 101, which connects the runner 100 to a slot 14. The runner 100 functions as a flow passage for supplying the plastic 30 in the filling pot 91 to a slot 14 different from the slot 14 connected to the connecting hole 94 of the filling pot 91. The runner 100 opens in the upper surface of the caul plate 90, and extends toward the different slot 14 from a part of the filling pot 91 in the circumferential direction. The opening of the runner 100 is closed by the facing surface 70a of the movable die 70 when the fixed die 60 and the movable die 70 are clamped. The connecting hole 101 opens in the bottom surface of the runner 100. The bottom surface of the runner 100 is flush with the bottom surface of the second reduced-dimension portion 93. Therefore, the connecting hole 94 and the connecting hole 101 open in the same plane. According to this configuration, since the bottom surface of the runner 100 is flush with the bottom surface of the second reduced-dimension portion 93, when the plastic 30 solidified in the filling pot 91 is separated from the caul plate 90 by being protruded by a pin or the like inserted into the connecting holes 94, 101, the plastic 30 is easily separated from the caul plate 90. This is because the plastic 30 after solidification is unlikely to remain on the bottom surface of the runner 100 and the bottom surface of the second reduced-dimension portion 93 due to the absence of a step between the bottom surface of the runner 100 and the bottom surface of the second reduced-dimension portion 93.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rotor manufacturing apparatus configured to manufacture a rotor including a tubular rotor core having a slot extending therethrough in an axial direction, a magnet accommodated in the slot, and a plastic filling the slot to fix the magnet to the rotor core, the rotor manufacturing apparatus comprising:
a first die and a second die configured to be clamped to sandwich, in the axial direction, the rotor core, including the magnet accommodated in the slot;
a caul plate that includes a filling pot configured to introduce the plastic into the slot, the caul plate being configured to be disposed between the first die and the rotor core; and
a plunger disposed in a receiving hole formed in the first die, the plunger being configured to protrude from and retract into a facing surface of the first die facing the caul plate and to extrude the plastic in the filling pot toward the slot, wherein
the plunger includes:
an enlarged-dimension portion; and
a reduced-dimension portion protruding from the enlarged-dimension portion to form a distal end of the plunger, the reduced-dimension portion having a width smaller than that of the enlarged-dimension portion, and
when the plunger extrudes the plastic in the filling pot, the plunger moves at least to a position at which the enlarged-dimension portion is flush with the facing surface.

2. The rotor manufacturing apparatus according to claim 1, wherein
the enlarged-dimension portion is a first enlarged-dimension portion and the reduced-dimension portion is a first reduced-dimension portion,
the filling pot includes:
a second enlarged-dimension portion that opens toward the first die; and
a second reduced-dimension portion that opens in a bottom surface of the second enlarged-dimension portion and has a width smaller than that of the second enlarged-dimension portion, and
when the plunger extrudes the plastic in the filling pot, the plunger stops at a position at which the first enlarged-dimension portion is located inside the second enlarged-dimension portion, and the first reduced-dimension portion is located inside the second reduced-dimension portion.

3. The rotor manufacturing apparatus according to claim 2, wherein a width of the second enlarged-dimension portion gradually increases toward the first die in the axial direction.

4. The rotor manufacturing apparatus according to claim 2, wherein a width of the second reduced-dimension portion is constant in the axial direction.

5. The rotor manufacturing apparatus according to claim 2, wherein a width of the second reduced-dimension portion is smaller than that of the receiving hole.

6. The rotor manufacturing apparatus according to claim 2, wherein the filling pot includes a connecting hole that opens in a bottom surface of the second reduced-dimension portion and connects the second reduced-dimension portion to the slot.

7. The rotor manufacturing apparatus according to claim 2, wherein
a width of the second enlarged-dimension portion is greater than that of the receiving hole, and
the plunger is configured to be retractable from the caul plate in a state in which the first die and the second die are clamped.

8. A rotor manufacturing method for manufacturing a rotor including a tubular rotor core having a slot extending therethrough in an axial direction, a magnet accommodated in the slot, and a plastic filling the slot to fix the magnet to the rotor core, the rotor manufacturing method comprising:
clamping a first die and a second die with the rotor core and a caul plate sandwiched therebetween in the axial direction in a state in which the caul plate is disposed at an end face in the axial direction of the rotor core accommodating the magnet, the caul plate including a filling pot configured to introduce the plastic into the slot; and
filling the slot with the plastic by extruding the plastic in the filling pot by using a plunger disposed in a receiving hole formed in the first die, the plunger being configured to protrude from and retract into a facing surface of the first die facing the caul plate, wherein
the plunger includes:
an enlarged-dimension portion; and
a reduced-dimension portion protruding from the enlarged-dimension portion to form a distal end of the plunger, the reduced-dimension portion having a width smaller than that of the enlarged-dimension portion, and
the filling the slot with the plastic includes moving the plunger at least to a position at which the enlarged-dimension portion is flush with the facing surface.

9. The rotor manufacturing method according to claim 8, wherein
the enlarged-dimension portion is a first enlarged-dimension portion and the reduced-dimension portion is a first reduced-dimension portion,
the filling pot includes:
a second enlarged-dimension portion that opens toward the first die; and
a second reduced-dimension portion that opens in a bottom surface of the second enlarged-dimension portion and has a width smaller than that of the second enlarged-dimension portion, and
the filling the slot with the plastic includes stopping the plunger at a position at which the first enlarged-dimension portion is located inside the second enlarged-dimension portion, and the first reduced-dimension portion is located inside the second reduced-dimension portion.

10. The rotor manufacturing method according to claim 8, wherein
the enlarged-dimension portion is a first enlarged-dimension portion and the reduced-dimension portion is a first reduced-dimension portion,
the filling pot includes:
a second enlarged-dimension portion that opens toward the first die; and
a second reduced-dimension portion that opens in a bottom surface of the second enlarged-dimension portion and has a width smaller than that of the second enlarged-dimension portion,
the rotor manufacturing method further comprises:
supporting the plastic using the second reduced-dimension portion in a state in which the caul plate is not located between the first die and the second die; and
transferring, to a position between the first die and the second die, the caul plate in a state in which the plastic is supported by the second reduced-dimension portion, and
the clamping the first die and the second die includes clamping the first die and the second die with the rotor core and the caul plate sandwiched therebetween in the axial direction after the caul plate is transferred to the position between the first die and the second die.

11. The rotor manufacturing method according to claim 8, wherein
the enlarged-dimension portion is a first enlarged-dimension portion and the reduced-dimension portion is a first reduced-dimension portion,
the filling pot includes:
a second enlarged-dimension portion that opens toward the first die; and
a second reduced-dimension portion that opens in a bottom surface of the second enlarged-dimension portion and has a width smaller than that of the second enlarged-dimension portion,
a width of the second enlarged-dimension portion is greater than that of the receiving hole, and
the rotor manufacturing method further comprises separating the plastic in the filling pot from the plunger by retracting the plunger from the caul plate in a state in which the first die and the second die are clamped.
